(19) United States
(12) Patent Application Publication
(10) Pub. No.: US 2018/0106239 A1
(43) Pub. Date: Apr. 19, 2018

(54) Wind Warrior

(71) Applicant: Bruce Logan Shrewsbury, El Paso, TX (US)

(72) Inventor: Bruce Logan Shrewsbury, El Paso, TX (US)

(21) Appl. No.: 15/297,078

(22) Filed: Oct. 18, 2016

(51) Int. Cl. F03D 3/06; F03D 3/00; F03D 9/00

(52) U.S. Cl. CPC F03D 3/064; F03D 3/005; F03D 3/061; F05B 2240/311; F03D 9/001; F05B 2240/211; F03D 9/002

(57) ABSTRACT

The Wind warrior is a wind turbine that is situated in the wind, horizontally so winds from all directions affect it equally without, the need for a rudder type directional control. The Wind Warrior has several veins, similar to umbrellas, at the ends of arms (trusses) that are connected to a center mandrel that turns with the arms as the wind drive; the veins attached to the outer ends of the arms. The wind acts upon the face side of the veins to spin them, transferring the wind force through the arms to the mandrel but partially closing the veins as they rotate into a position where the wind acts upon their back side. Drag is reduced due to the veins partially closing as they rotate until the face side is again exposed to the force of the wind and is opened and driven thereby to rotate the mandrel.

The mandrel connects with sprockets and chains, pulleys and belts, gears or any obvious connecting method, to any energy producing mechanism such as electrical alternators/generators, air compressors, hydraulic pumps/motors, winches, Etc. Etc.

The veins offer a large solid surface for the wind to act upon so that the full force of the wind converts Into mechanical energy. The torque achieved depends upon the length of the arms that, the veins are attached to. The power is a product of the vein size (square Foot surface area) X the Wind force/velocity X tork.

The Wind Warrior is highly efficient because the veins close as they rotate into position for their back side to be acted upon. Because of this efficiency and the action of the wind on the face side of veins as if it were on a solid wait the Wind Warrior produces usable energy with very low velocity winds. Three to four mile per hour winds produce useable energy as opposed to a requirement of seven mile per hour winds for conventional, propeller type wind turbines. This means that the Wind Warrior produces energy more constantly than do propeller type turbines and with lower wind force requirement.

Because of the shape and type of veins (umbrella like), construction can be of very light weight materials (sail cloth with light skeletal like framework. This adds to the ability to convert wind energy to mechanical energy. The lighter the mechanism, the less energy is needed to move it.

Because of its high efficiency the Wind Warrior is practical as a small unit, sized for individual home energy needs. It can be built in larger sizes also, but is very practical as a small unit and will be within the economic grasp of individuals for their homes and shops.

The arms, or trusses that the veins are mounted on are connected together with bridging (not shown on drawing sheet 1) so that force against one vein acts upon the entire arm structure as a unit. Because the turbine has five or more veins, more than one vein will always be acted upon by any wind.

### DESCRIPTION OF DRAWINGS

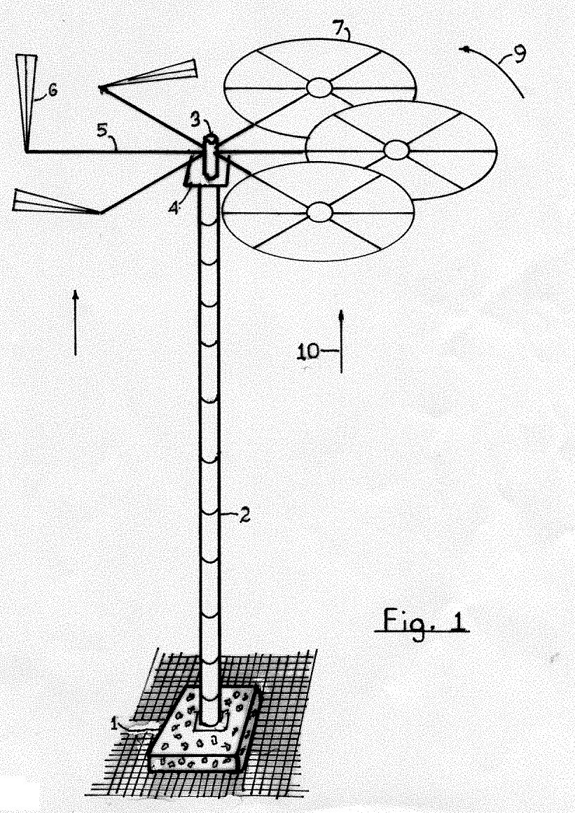

### FIG. 1—Drawing Page 1

### Elevation

1 Steel reinforced concrete base of sufficient weight & strength to support Wind Warrior.
2 Wind Warrior Tower; any obvious tower built strong enough to support the turbine with the force of the wind.
3 Mandrel that is rotated by an arm or truss/vein combination that is Driven by the wind. Mandrel drives energy producing apparatus. Mandrel rotates on bearings that are mounted on an obvious shaft That is mounted on the top of the tower.
4 Base Plate for mounting energy producing apparatus such as generator, Compressor, Etc.
5 Arm/truss that is attached on one end to the mandrel (3). The opposite end of the arm attaches to the vein (6&7) that the wind acts upon. For Clarity, the arms are drawn here as single pipe or tube but they will be trusses tied together by bridging trusses. These will be shown in more detailed drawings of individual parts.
6 Back side of vein that closes when wind force brings it (back side) into position for the wind force to close it.
7 Face side of vein that is opened by the same wind force that causes it to Rotate along with arm/truss and mandrel.
8 Curved arrow shows direction of rotation of turbine.
9 Straight arrows show wind direction.

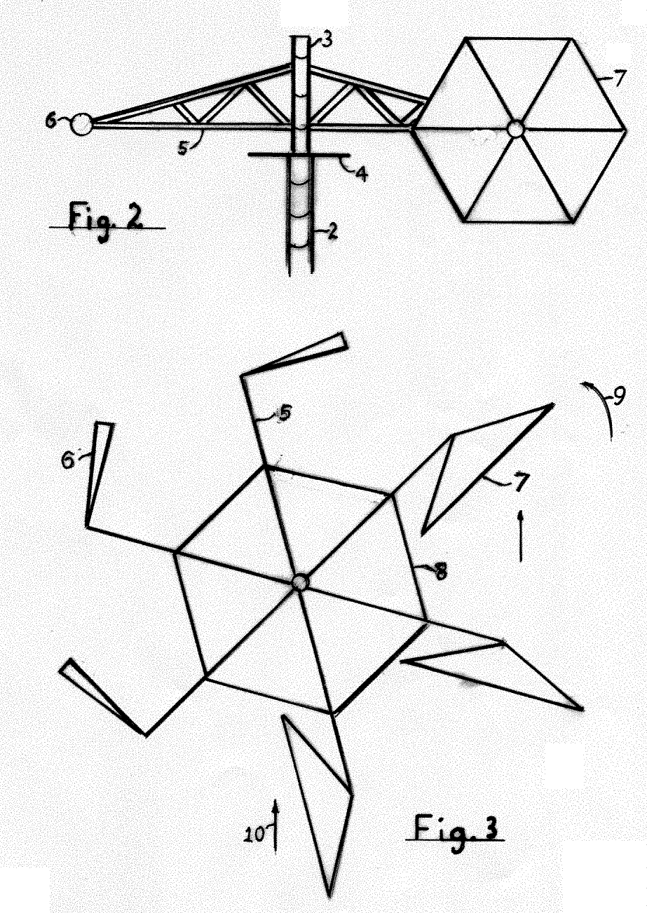

### FIG. 2 Drawing Page 2

### Elevation

2 Tower-any obvious tower built strong enough to support the turbine with the force of the wind.
3 Mandrel that is rotated by arm or truss/vein combination driven by wind. Mandrel drives energy producing apparatus. Mandrel rotates on ball bearings that are mounted on an obvious shaft that is mounted on the tower.
4 Base plate for mounting energy producing apparatus such as electrical generator, compressor, pump Etc. Alternatively, a shaft will run from the mandrel to a mounting plate close to the ground for turning energy producing equipment at a more convenient position for servicing Etc.
5 Arm/truss that on one end is attached to Mandrel (3). The opposite end of arm/truss attaches to the vein upon which the wind acts.
6 vein that has been closed by rotation of mandrel & arm bringing it to a position for wind to act on and to close it.
7 Face side of vein fully opened by wind force acting upon it when Rotation off Mandrel and arm have brought it to face the wind.

### FIG. 3 Drawing Page 2

### Plan view

5 Arm/truss that connects between mandrel and wind vein (6&7).
6 Wind vein in a closed condition.
7 Wind vein in an open condition
8 Bridging between arms/trusses that ties them together so that power from vein transmits through all arms together into the mandrel.
9 Direction of rotation of turbine,
10 Direction of wind acting upon the turbine.

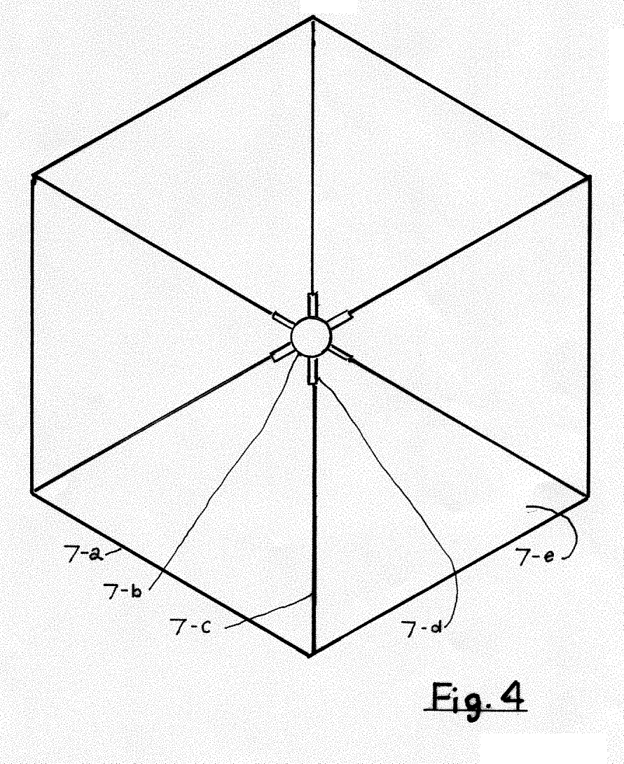

### FIG. 4 Drawing Page 3

### Elevation

7-a Umbrella-like vein that opens and closes in wind to transfer wind Force to apparatus that vein attaches to.
7-b hub upon which rod holders rotate. Rotation is for opening and Closing vein
7-c Rod attached to rod holder. The rods are the skeletal structure of the vein.
7-d Rod holder with ball bearings attaching it to the hub for rotation that Opens and closes the rods and hence the vein that when opened Transfers power from the wind to the arm/trusses and hence to the Mandrel.
7-e Sail cloth or other strong, flexible fabric that is weather resistant The sail cloth attaches to the rods and when opened presents resistance to the wind. It is the winds overcoming this resistance, forcing the vein into motion that creates the generated power.

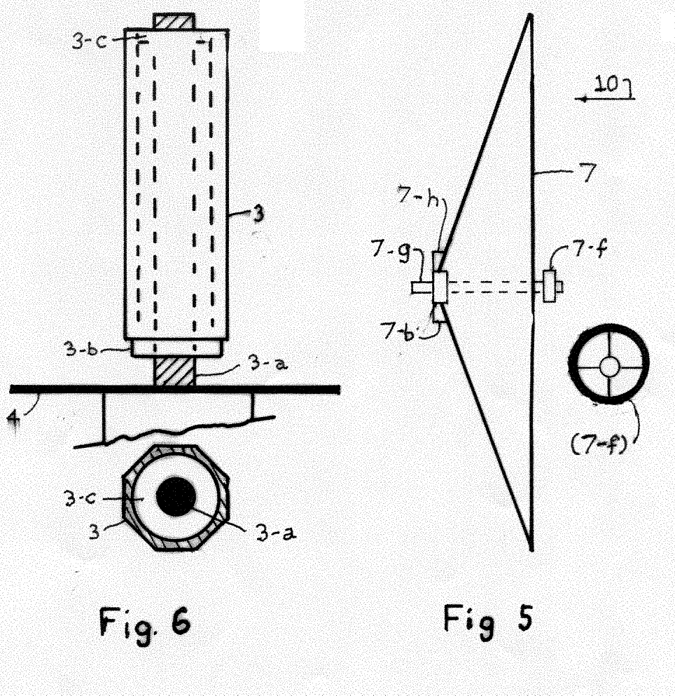

### FIG. 5 Drawing Page 4

### Elevation

7 Wind vein in opened condition (side elevation view)
7-b Hub upon which rod holders pivot to open and close vein.
7-f Control ring that stops vein from closing too much so that the wind cannot open it efficiently as possible when positioned for opening.
7-g Bolt in center of hub, and control rings for attachment to arm/truss (Truss shown on FIGS. 1&2)
7-h Hub Control ring that controls extent of opening the vein. Rods rest on this ring when vein is fully opened.
10 Shows direction of wind acting upon opened vein.

### FIG. 6 Drawing Page 4

### Elevation and Plan View

3 Outer structure of mandrel to which arm/trusses attach. Pulley Sprocket or gear also attach to the mandrel to drive energy Producing, equipment.
3-a Inner part of mandrel (shaft mounted on tower)
3-b Miss-numbered. Should be 3-c bearing. Mandrel will have 3-c Bearing top and bottom, between shaft and outer structure of Mandrel.
4 Mounting plate for mounting of energy producing equipment

What is claimed is:

1 Opening and dosing, umbrella type veins, when opened, offer a solid surface for the wind to act upon but as they rotate around a central mandrel, they offer their back side which closes them to give little resistance to wind as they rotate into position to be opened and acted upon again, repetitively, as solid rotatable surfaces.

2 Arms/trusses (Number 5 of drawings) that carry the veins (number 6 & 7 of drawings) at extreme ends are attached to a rotating mandrel (number 3 of drawings) at their opposite end. The mandrel is connected to energy producing apparatus (not shown because any obvious apparatus can be used). The speed (RPM's) of the mandrel is directly proportional to the speed of the wind. While the power produced is directly proportional to the size (Sq. Ft, surface) of the vein X the force/speed of the wind and the torque is proportional to the length of the vein supporting arms. Because of these factors, the Wind Warrior produces useable power at lower wind velocities than do conventional wind turbines

3 The opening and closing veins (5 or more) are carried on trusses that are connected by bridging (see number 8 on FIG. 3 of drawings) so that the turning action is transmitted from any one of the veins into and through the entire arm/truss system. This allows for light-weight construction while providing strength to withstand fairly high winds. The trusses must be constructed of light weight material such as aluminum while the veins must be sail cloth, parachute cloth or other light weight material that is strong and also sun and weather resistant (see numbers 5 through 7 of drawings). The Wind Warrior has five or more arm/vein combinations, so that a straight forward wind will at all times act upon more than one vein. This produces a sooth constant action instead of the choppy action that can occur with 4 or less veins.
